(19) United States
(12) Patent Application Publication
(10) Pub. No.: US 2021/0012239 A1
(43) Pub. Date: Jan. 14, 2021

(54) AUTOMATED GENERATION OF MACHINE LEARNING MODELS FOR NETWORK EVALUATION

(71) Applicant: Microsoft Technology Licensing, LLC, Redmond, WA (US)

(72) Inventors: Behnaz ARZANI, Redmond, WA (US); Bita Darvish Rouhani, Bellevue, WA (US)

(73) Assignee: Microsoft Technology Licensing, LLC, Redmond, WA (US)

(21) Appl. No.: 16/510,223

(22) Filed: Jul. 12, 2019

(51) Int. Cl. G06N 20/00; H04L 12/26

(52) U.S. Cl. CPC G06N 20/00; H04L 43/0811; H04L 43/50

(57) ABSTRACT

This document relates to automating the generation of machine learning models for evaluation of computer networks. Generally, the disclosed techniques can obtain network context data reflecting characteristics of a network, identify a type of evaluation to be performed on the network, and select a particular machine learning model for evaluating the network based at least on the type of evaluation. The disclosed techniques can also select one or features to train the particular machine learning model.

### BACKGROUND

Traditionally, machine learning models are selected and deployed by individuals with machine learning backgrounds, often experts with deep understanding of the various types of machine learning models and their respective strengths and weaknesses. In addition, these experts often need to have some expertise in a specific problem domain in order to fully understand how machine learning can be utilized to address problems arising in that domain.

As a consequence, it is difficult for even very skilled experts to readily develop and deploy machine learning models. An alternative approach involves automated generation of machine learning models, but this approach tends to involve a great deal of computational resources and fails to adequately leverage domain knowledge for specific problem domains.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for automated generation of machine learning models. One example includes a system that entails a hardware processing unit and a storage resource. The storage resource can store computer-readable instructions which, when executed by the hardware processing unit, cause the hardware processing unit to obtain network context data identifying a plurality of nodes of a network and identify a specified type of evaluation to be performed on the network. The computer-readable instructions can also cause the hardware processing unit to select a particular machine learning model to perform the evaluation, based at least on the specified type of evaluation. The computer-readable instructions can also cause the hardware processing unit to select features to use with the particular machine learning model, based at least on the network context data. The computer-readable instructions can also cause the hardware processing unit to train the particular machine learning model using the selected features to obtain a trained machine learning model and to output the trained machine learning model. The trained machine learning model can be configured to perform the specified type of evaluation on the network.

Another example includes a method or technique that can be performed on a computing device. The method or technique can include providing network context data identifying nodes of a network to an automated machine learning framework and providing first input data to the automated machine learning framework. The first input data can describe behavior of the nodes of the network. The method or technique can also include receiving a trained machine learning model from the automated machine learning framework and executing the trained machine learning model on second input data describing behavior of the nodes of the network to obtain a result.

Another example includes a computer-readable storage medium storing instructions which, when executed by a processing device, cause the processing device to perform acts. The acts can include receiving input via a user interface. The input can select one or more values of network context data for evaluating a network. The acts can also include converting the one or more values of the network context data into a domain-specific language representation of the network context data. The acts can also include selecting a particular machine learning model to evaluate the network based at least on the domain-specific language representation of the network context data. The particular machine learning model can be selected from one or more pools of candidate machine learning model types.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example network that can be evaluated using some implementations of the present concepts.

FIGS. 2, 4, 5, and 6 illustrate example processing flows, consistent with some implementations of the present concepts.

FIG. 3 illustrates an example connectivity graph, consistent with some implementations of the present concepts.

FIG. 7 illustrates an example system, consistent with some implementations of the present concepts.

FIGS. 8A, 8B, and 9 illustrate example graphical user interfaces, consistent with some implementations of the present concepts.

FIG. 10 illustrates an example method or technique for automated generation of a machine learning model, consistent with some implementations of the present concepts.

FIG. 11 illustrates an example method or technique for employing a machine learning model, consistent with some implementations of the present concepts.

### DETAILED DESCRIPTION

### Overview

Broadly speaking, the disclosed implementations aim to provide for automated generation of machine learning models for network evaluation. Typically, network engineers have a great deal of expertise in the structure of computer networks, what types of problems tend to arise, and how some aspects of the network can influence performance and reliability. However, network engineers rarely have significant experience in machine learning, and thus may be ill-equipped to manually select or configure machine learning models to help solve problems that may arise in computer networks.

One approach for selecting a machine learning model for a given application is to use automated model selection techniques. By evaluating numerous potential models, automated model selection techniques can often output machine learning models that are reasonably likely to be successful at solving a given problem. However, depending on the problem space, this can involve significant amounts of computing resources, to the point where automated model generation becomes computationally expensive or even computationally intractable.

One factor that can influence the computational expense associated with automated machine learning model generation is the different types of models that are considered. For example, a technique that only considers convolutional neural networks with predetermined limit on the number of layers has a much smaller problem space than another technique that also considers a broader range of neural networks or other model types, such as decision trees or support vector machines.

Another factor that can influence the computational expense associated with automated machine learning model generation is the number of candidate features under consideration. In the networking space, there are often a tremendous number of candidate features that could potentially be used to train a machine learning model. As a consequence, machine learning model generation techniques can expend a significant amount of computational resources learning which candidate features are useful for solving different types of network problems.

The disclosed implementations aim to constrain the problem space for generating machine learning models to evaluate networks, while still considering a relatively broad range of potential machine learning model types, potential hyperparameters, and/or potential features. To do so, the disclosed implementations leverage information about a particular network under consideration, such as the number of nodes in the network, the type of nodes, connectivity, etc. The disclosed implementations also leverage information that may indicate which features tend to influence specific types of network behavior. By using this information in conjunction with a particular type of evaluation to be performed on the network, the disclosed implementations can select a particular machine learning model type, hyperparameters for the particular model type, and a subset of available features to use in training, as discussed more below.

### Example Network Architecture

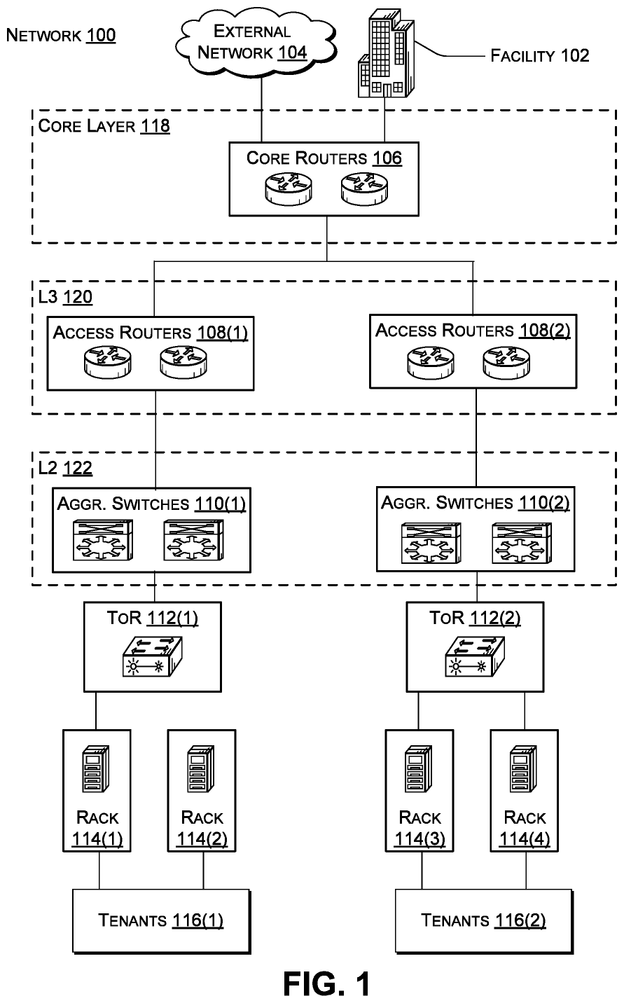

FIG. 1 illustrates an example of a network 100 that can be evaluated using the concepts discussed herein. The network can be manifest in a facility 102 that is connected to an external network 104, such as the Internet. In this case, the network 100 includes devices or components such as one or more core routers 106(1) and 106(2), one or more access routers 108(1) and 108(2), one or more aggregation switches 110(1) and 110(2), one or more top-of-rack (ToR) switches 112(1) and 112(2), and/or one or more racks 114(1), 114(2), 114(3), and 114(4). Each of the racks 114 can include one or more server devices that host tenants 116(1) and/or 116(2).

Note that different instances of the various devices in FIG. 1 are distinguished by parenthetical references, e.g., 112(1) refers to a different ToR switch than 112(2). When referring to multiple devices collectively, the parenthetical will not be used, e.g., ToRs 112 can refer to either or both of ToR 112(1) or ToR 112(2). Note also that network 100 can include various devices or components not shown in FIG. 1, e.g., various intrusion detection and prevention systems, virtual private networks (VPNs), firewalls, load balancers, etc.

From a logical standpoint, the network 100 can be organized into a hierarchy that includes a core layer 118, an L3 aggregation layer 120, and an L2 aggregation layer 122. This logical organization can be based on the functional separation of Layer-2 (e.g., trunking, virtual local area networks, etc.) and Layer-3 (e.g., routing) responsibilities. In FIG. 1, a limited number of network devices and applications are shown, but the disclosed implementations can be implemented with any number of networking devices and/or applications. Furthermore, note that network 100 is just one example, and various other network structures are possible, e.g., the concepts disclosed herein can be employed in networks that range from relatively small networks without L2/L3 aggregation to massive server farms used for high-performance cloud computing.

In some cases, network devices are deployed redundantly, e.g., multiple access routers can be deployed in redundancy groups to provide redundancy at the L3 aggregation layer 120. Likewise, in implementations with multiple aggregation switches, the multiple aggregation switches can be deployed in redundancy groups to provide redundancy at the L2 aggregation layer 122. Generally, in a redundancy group, the group contains multiple members and individual members can perform the switching/routing functions when other member(s) of the redundancy group fail.

ToRs 112 (also known as host switches) connect the servers hosted by the racks 114 to a remainder of the network 100. Host ports in these ToR switches can be connected upstream to the aggregation switches 110. These aggregation switches can serve as aggregation points for Layer-2 traffic and can support high-speed technologies such as 10 Gigabit Ethernet to carry large amounts of traffic (e.g., data).

Traffic from an aggregation switch 110 can be forwarded to an access router 108. The access router can use Virtual Routing and Forwarding (VRF) to create a virtual, Layer-3 environment for each tenant. Generally, tenants 116(1) and 116(2) can be software program, such as a virtual machines or applications, hosted on servers which use network devices for connectivity either internally within facility 102 or externally to other devices accessible over external network 104.

Some tenants, such as user-facing applications, may use load balancers to improve performance. Redundant pairs of load balancers can connect to an aggregation switch 110 and perform mapping between static IP addresses (exposed to clients through the Domain Name System, or DNS) and dynamic IP addresses of the servers to process user requests to tenants 116. Load balancers can support different functionalities such as network address translation, secure sockets layer or transport layer security acceleration, cookie management, and data caching.

Firewalls can be deployed in some implementations to protect applications from unwanted traffic (e.g., DoS attacks) by examining packet fields at IP (Internet Protocol) layer, transport layer, and sometimes even at the application layer against a set of defined rules. Generally, software-based firewalls can be attractive to quickly implement new features. However, hardware-based firewalls are often used in data centers to provide performance-critical features.

Virtual private networks can augment the data center network infrastructure by providing switching, optimization and security for web and client/server applications. The virtual private networks can provide secure remote access. For example, the virtual private networks can implement secure sockets layer, transport layer security, or other techniques.

### Example Processing Flow

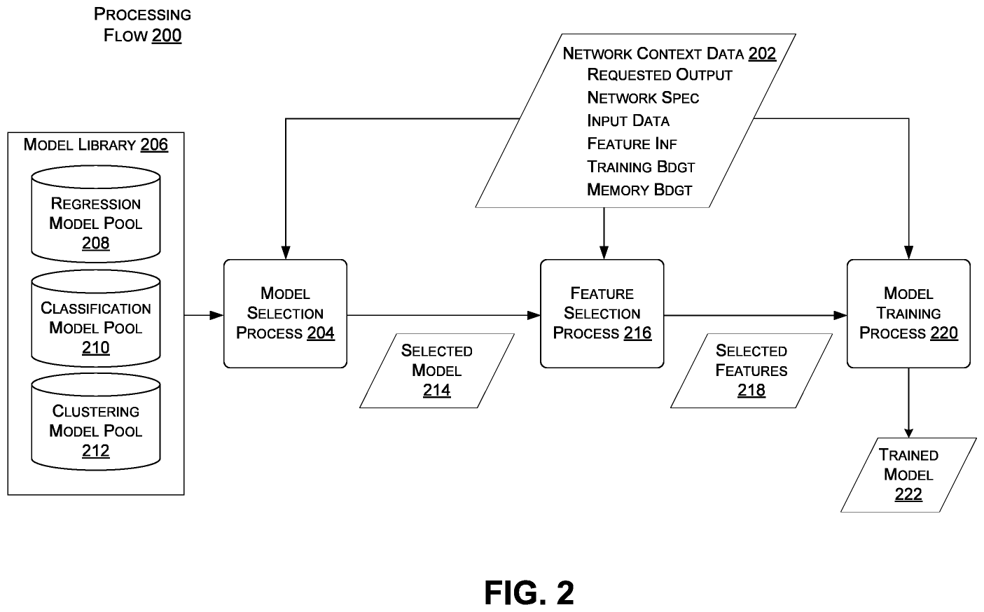

FIG. 2 illustrates an example processing flow 200, consistent with the disclosed implementations. Processing flow 200 utilizes network context data 202 to select, configure, and/or train one or more machine learning models, as discussed more below. As used herein, the term “network context data” can include various types of information relating to network evaluation using machine learning models. For example, the network context data can include a requested output, a network specification, input data, feature information, a training budget, and a memory budget, among other things.

Generally, the network context data 202 can include a requested output that characterizes the type of evaluation to be performed on the network, e.g., indicates what output(s) the machine learning model should learn to provide. For instance, the network context data can identify a broad category of problem being solved, e.g., congestion control, diagnosis, traffic engineering, etc. In other cases, the network context data can identify a specific value to learn, e.g., an optimal or near-optimal congestion window for a protocol such as Transmission Control Protocol (“TCP”).

The network context data 202 can also include a network specification that describes the network being evaluated, e.g., by identifying specific types of software and/or hardware nodes on the network as well as connectivity information for those nodes. The input data can identify a data source with data that describes behavior of various nodes on the network. For example, the input data can include various input data fields and, in some cases, labels describing outcomes associated with the input data. For example, the input data could be a list of TCP statistics at different times together with labels indicating node-to-node latency between different nodes of the network at those times. The feature information can include information that indicates what input data fields are likely to be useful features for the requested output, and/or information indicating what input data fields are likely to be irrelevant and thus not useful as features. The training budget can convey a constraint on the amount of training to be performed, e.g., a number of processing cycles or time of execution on standardized hardware. For instance, the training budget can be expressed in a number of days that are allocated to train a given model on a specific model of graphical processing unit or “GPU.” The memory budget can convey a constraint on the final model size, e.g., in gigabytes.

Processing flow 200 begins with model selection process 204, which evaluates candidate machine learning model types from a model library 206 of candidate machine learning model types. FIG. 2 illustrates three pools of candidate machine learning model types—regression model pool 208, classification model pool 210, and clustering model pool 212. Generally, each candidate model pool can include various candidate model types that are appropriate for performing a particular type of evaluation, e.g., regression, classification, and clustering, respectively. Note that these model pools are examples and other implementations may use alternative arrangements of candidate model types for model selection.

The model selection process 204 can involve selecting a particular model pool based on the network context data 202. For instance, the model pool can be selected based on the type of output requested by the network context data. As one example, if the network context data requests that the machine learning model identify a relationship between latency or congestion and other values in the input data, this can be modeled as a regression problem and thus the regression model pool 208 can be selected. As another example, if the network context data requests that the machine learning model assign values from a predefined range of integer or enumerated values and these values are provided as labels in the input data, this can be modeled as a classification problem and thus the classification model pool 210 can be selected. As another example, if the network context data requests that the machine learning model learn to identify groups of related items and there are no explicitly labeled groups in the input data, this can be modeled as an unsupervised learning task appropriate for a clustering model selected from the clustering model pool 212.

Once a given model pool is selected, the model selection process 204 can select a specific model type from the selected pool. To do so, the model selection process can evaluate information such as the type and amount of input data that are available, the training and memory budgets, etc. Generally, these items of information can help inform which machine learning models are appropriate to the task at hand. For instance, assume the classification model pool 210 has been selected, and the classification model pool includes a deep neural network model type and a decision tree model type. In a scenario where the network context data 202 indicates that there is a vast amount of input data for training with high training and memory budgets, the deep neural network model type might be selected, as deep neural networks tend to be very accurate but can require extensive training and can be rather computationally intensive when deployed. As another example, a decision tree model type might be selected when the network context data indicates that there is limited training data and a limited training and/or memory budget.

In addition, the model selection process 204 can also select model hyperparameters for the selected model type. In the case of a neural network model type, the hyperparameters can include the learning rate, number of nodes per layer, types of layers, depth, etc., each of which has a range of potential values. In the case of a random forest model type, the hyperparameters can include the number of decision trees, the number of features to consider for each tree for node-splitting, etc. In some cases, the training budget and/or memory budget in the network context data can influence the selection of hyperparameters. In other scenarios, characteristics of the input data can influence the selection of hyperparameters, as discussed more below. Collectively, the selected model type and selected hyperparameters can be output from the model selection process as selected model 214.

Feature selection process 216 can occur before, after, or in parallel with model selection process 204. Generally, the feature selection process can evaluate the input data as well as any feature information in the network context data 202 to determine which fields in the input data are likely to be useful features for machine learning. In some cases, the network context data may include a network specification that identifies network characteristics such as network topology or communication patterns on the network. For instance, if two virtual machines do not both utilize a common link of the network topology, then the latency of one of those virtual machines is unlikely to have any influence on the latency of the other. As a consequence, the respective latency of each virtual machine can be excluded during the feature selection process for a regression task that estimates the network latency of individual virtual machines.

As another example of feature selection process 216, assume the task is to estimate network congestion. The input data might indicate whether individual nodes have performed zero-window probing, which is a TCP technique where a sender queries a remote host that advertises a zero-window size until the remote host increases its window size. Zero-window probing is unlikely to indicate network congestion issues. Thus, the feature information in the network context data 202 can indicate that zero-window probing should be excluded as a feature when the requested output relates to network congestion.

Feature selection process 216 can output selected features 218 to a model training process 220. The model training process can use the selected features to train the selected model and output a trained model 222. In some cases, the amount of training can be constrained based on the training budget specified by the network context. In other examples, training can proceed until available input data for training is exhausted, until a convergence condition is reached, when a threshold level of accuracy is obtained, etc. Once trained, the machine learning model is configured to perform the type of evaluation specified by the network context data.

### Example Connectivity Data

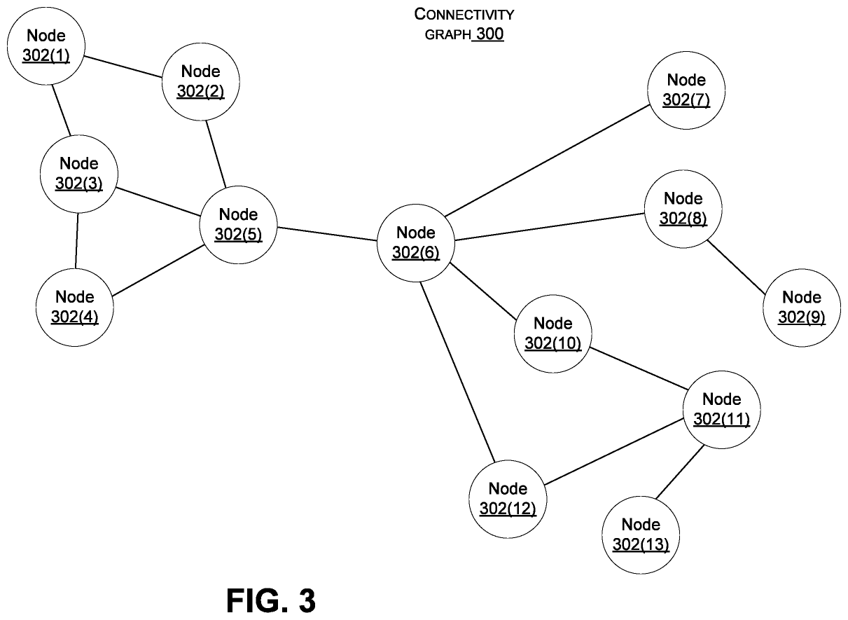

As noted, networking context data 202 can include a network specification that generally described the network that will be evaluated by the selected machine learning model. In some cases, the network specification can include representation of connectivity among various software/hardware nodes. As just one example, FIG. 3 illustrates an example connectivity graph 300 with a plurality of nodes 302. Each node can represent a software or hardware entity in network 100 shown in FIG. 1, such as a switch, router, server, tenant, etc. Generally, depending on the physical connections as well as configuration settings in the network, certain nodes will be in direct “one-hop” communication with one another, as represented by edges in connectivity graph 300. In some cases, the connectivity graph can be specified manually, but in other cases can be automatically inferred. For example, some implementations may use a network service that provides programming interfaces to query node connectivity, e.g., a network graph service. Other implementations can perform an automated evaluation of traffic flows or node configuration data to infer the topology and/or connectivity of the network.

Note that certain nodes may be in a “critical path” between any two other nodes. For example, assume node 302(1) attempts to communicate with node 302(7). Node 302(1) can communicate through node 302(2) without using node 302(3) or vice-versa, but in any event communications between these two nodes must go through nodes 302(5) and 302(6). Thus, nodes 302(5) and 302(6) are on the critical path between nodes 302(1) and 302(7), whereas nodes 302(2) and 302(3) are not on the critical path. In some implementations, the selected features can include one or more features that indicate whether a given node is on the critical path between two other nodes, as discussed more below.

### Regression Processing Flow Example

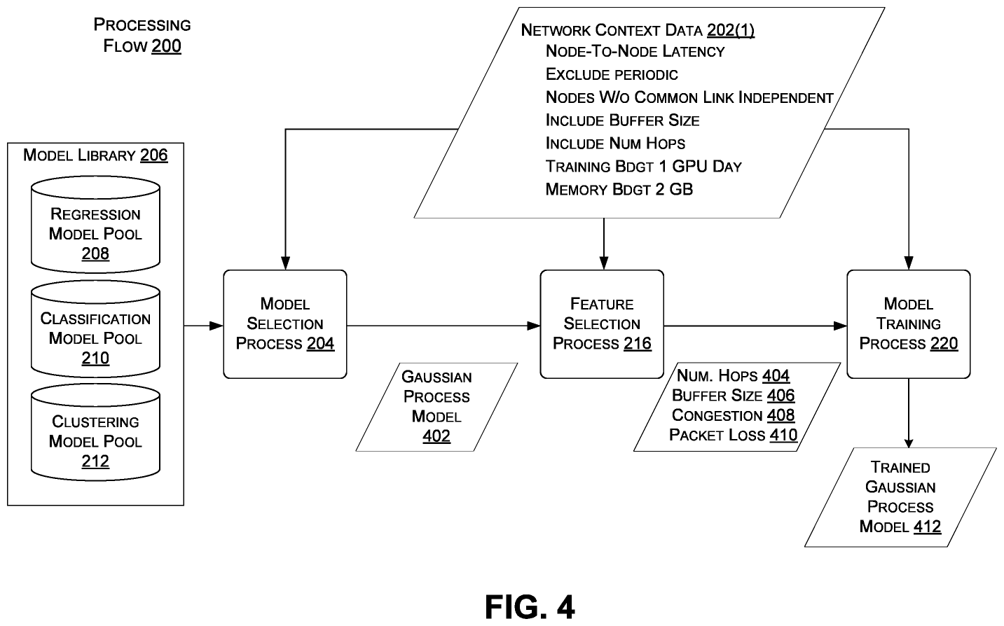

FIG. 4 illustrates a first example of how processing flow 200 can output a given model. In this example, an instance of network context data 202(1) includes an indication that the machine learning model is requested to output node-to-node latency between different nodes on the network. The network context data also includes various fields that can be used to constrain the model selection process 204, feature selection process 216, and/or model training process 220, as discussed more below.

For example, network context data 202(1) includes a field indicating that periodic functions should not be used to model the node-to-node latency. In addition, the network context data indicates that nodes that do not share a common link are likely to be latency-independent. The network context data also includes fields specifying that buffer sizes of network devices and the number of hops between nodes should be considered as features for the latency evaluation, as well as values of 1 GPU day for the training budget and 2 gigabytes for the memory budget.

Because the network context data 202(1) includes a requested output of node-to-node latency, the model selection process 204 can select a machine learning model type that can learn a relationship between network conditions and latency between nodes. For example, the model selection process can infer that the requested output of node-to-node latency can be modeled as a regression task, and thus can select the regression pool model for further evaluation of various candidate regression model types. In some cases, the latency data used as the labels may be in a floating-point format, and this may be indicative that a regression model is appropriate.

In this example, assume that the regression pool model types include a Gaussian process model type, a linear regression model type, a polynomial regression model type, and a deep learning neural network regression model type. In this example, the model selection process 204 can select the Gaussian process model type and associated hyperparameters, for reasons that follow.

The model selection process 204 can have a first preconfigured rule indicating that a deep learning neural network model type is selected when the training budget is at least 50 GPU days and the memory budget is at least 16 gigabytes. The model selection process can have a second preconfigured rule that selects the Gaussian process model type in instances where the training budget is less than 50 GPU days but at least 0.5 GPU days, and the memory budget is less than 16 gigabytes and at least 1 gigabyte. The model selection process can have a third preconfigured rule stating that linear or polynomial regression model types should be selected when the network context data 202(1) explicitly indicates that these models should be selected.

In this case, note that the specified training budget in network context data 202(1) is one GPU day, and the specified memory budget is 2 gigabytes. Thus, according to the first preconfigured rule, there is insufficient training budget for the deep learning neural network model type. Since the network context data 202(1) does not state that linear or polynomial regression types should be selected and the memory and training budgets are adequate according to the second preconfigured rule, the model selection process 204 can select the Gaussian process model type.

The model selection process 204 can also select model hyperparameters for the particular model type that has been selected. In the case of a Gaussian process model type, the hyperparameters include a kernel type that is used, e.g., a linear kernel, a periodic kernel, an exponential kernel, etc. In this example, the network context data 202(1) indicates that the latency should not be modeled as a periodic function, so the model selection process excludes this kernel type. The model selection process 204 might select a single kernel such as an exponential kernel for subsequent training. In other implementations, the model selection may select multiple kernels, e.g., linear and exponential kernels, as candidate kernels for training and further evaluation, as discussed more below.

Generally, any field of the input data can be considered a candidate feature. Thus, the feature selection process 216 can select one or more fields of the input data as features to use for training the selected Gaussian process model. In this example, the network context data 202(1) includes feature information explicitly indicating that the number of hops and network device buffer size should be used as features, so these are output by the feature selection process as number of hops 404 and buffer size 406. In addition, the feature selection process can perform an automated evaluation of each of the fields of the input data and infer that congestion and packet loss also are correlated to latency, so these are output by the feature selection process as congestion 408 and packet loss 410. More generally, the features selected by the feature selection process can include both features specifically identified by the network context data for inclusion as features, as well as other features that are automatically selected by the feature selection process.

Next, the model training process 220 can train the selected Gaussian process model 402 with the designated hyperparameters using the selected features. In this case, the network context data 202(1) also indicates that the latency of nodes that do not share common links is likely to be independent. Thus, in this case, the training of the Gaussian process model can assume that the covariance of the latency of any two such nodes is fixed at zero. This can speed the process of training the covariance matrix for the Gaussian process model.

In addition, the model training process 220 can use the specified training budget to train the Gaussian process model. In this instance, the model training process can limit the total training to one GPU day of training, as specified by network context data 202(1). When training completes, the model training process can output trained Gaussian process model 412.

### Classification Processing Flow Example

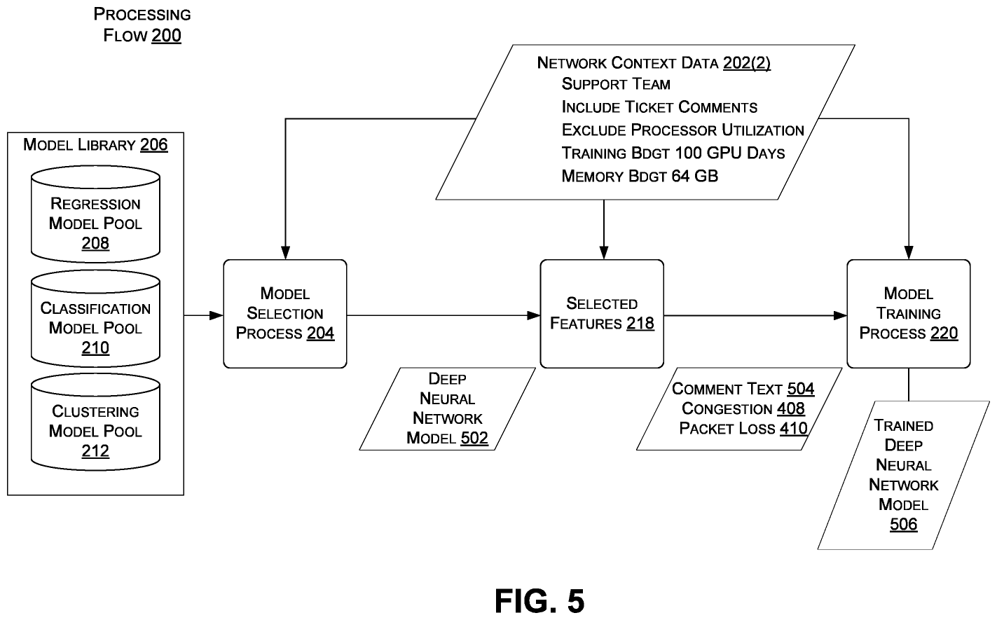

FIG. 5 illustrates a second example of how processing flow 200 can output a trained model. In this example, network context data 202(2) includes an indication that the machine learning model is requested to identify which support team should handle different trouble tickets. The network context data 202(2) also indicates that a comments field of the trouble tickets should be used as a feature. This could reflect an assessment by a network engineer that the trouble tickets have freeform comments in text form that are likely to be useful for learning which support team should handle the tickets. In this example, network context data 202(2) also indicates that processor utilization should not be used as a feature. This could be based on an assessment by the network engineer that processor utilization tends to vary naturally as a result of the load imposed by a given application or virtual machine on a given server, and is not typically indicative of how a trouble ticket should be handled.

Because the network context data 202(2) requests that the machine learning model learn which particular team should handle a given trouble ticket, the model selection process 204 can infer that the requested output can be modeled as a classification task. For instance, the input data may include previous examples of trouble tickets with associated values reflecting an enumerated list of support teams that successfully resolved those trouble tickets. More generally, when the input data includes labels in an integer or enumerated format, this may be indicative that the requested output can be modeled as a classification problem. Thus, in this example, the model selection process can select the classification model pool 210 for further evaluation of various candidate classification model types.

In this example, assume the classification model pool 210 includes a logistic regression model type, a decision tree model type, a random forest model type, a Bayesian network model type, a support vector machine model type, and a deep learning neural network model type. In this example, the training budget is substantial—100 GPU days, and the memory budget of 64 gigabytes will accommodate a deep neural network model with many features. Thus, in this example, the model selection process 204 can select a deep learning neural network model type.

As noted previously, the model selection process 204 can also select model hyperparameters for the particular model type that is selected. In this case, since the network context data 202(2) indicates that a freeform text field such as trouble ticket comments should be used as a feature, the model selection process might favor a deep learning neural network with a long short-term memory layer and/or a semantic word embedding layer, as these types of layers lend themselves to processing freeform text. As another example, given the substantial training and memory budgets, the model selection process may select densely-connected network layers, whereas for lower training or memory budgets the model selection process might select relatively more sparse layer-to-layer connections.

The feature selection process 216 can exclude processor utilization from the selected features for reasons indicated above, e.g., the network context data 202 includes feature information indicating that processor utilization is likely irrelevant or not particularly indicative of which support team should handle a given trouble ticket. The feature selection process 216 can also explicitly include the comment text 504 of the trouble tickets as a selected feature, as indicated by feature information in the network context data. Automated feature selection techniques can be used to select one or more other features to use for training, e.g., congestion 408 and packet loss 410. Note that the training and/or memory budgets can influence feature selection as well, e.g., relatively more features can be selected if there is more available training and/or memory budget.

Next, the model training process 220 can train the deep learning neural network classification model 502 with the selected features, consistent with the training budget. The model training process can output trained deep neural network model 506, which can be trained to select different teams to handle different trouble tickets in response to future network conditions.

### Clustering Processing Flow Example

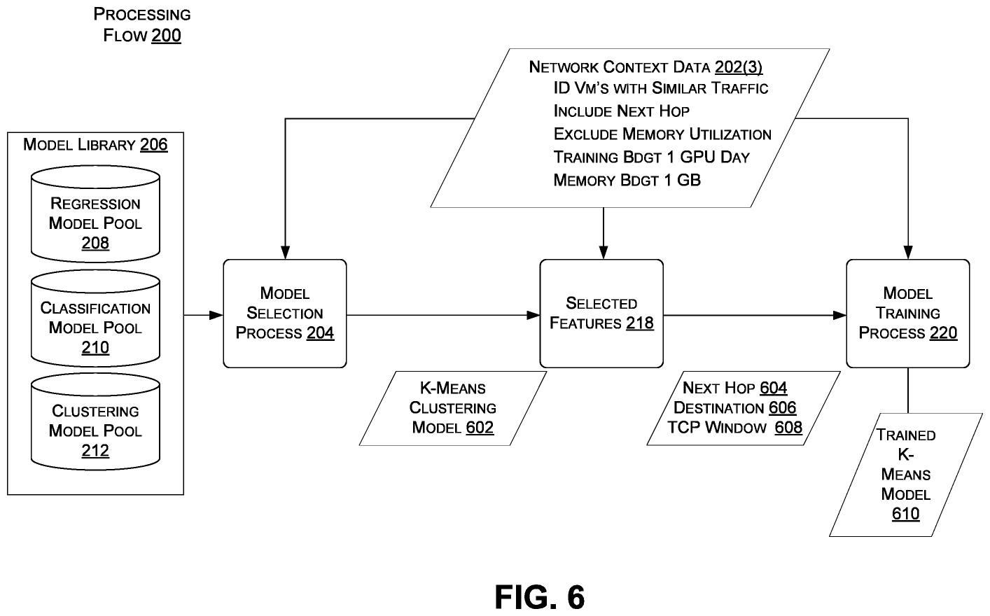

FIG. 6 illustrates a third example of how processing flow 200 can output a trained model. In this example, network context data 202(3) includes an indication that the machine learning model is requested to identify virtual machines that exhibit similar behavior, e.g., have similar network traffic patterns. For instance, this could be useful for subsequent processing where the virtual machines in a given cluster are scheduled on the same server rack, so that inbound and outbound traffic from that server rack tends to flow to the same nodes. In this example, the network context data also includes feature information indicating that the next-hop neighbor of each virtual should be used as a feature, and that memory utilization should not be used as a feature.

In this case, the input data may lack labels for training. In other words, the input data may not explicitly identify groups of virtual machines that have similar traffic patterns. As a consequence, the model selection process 204 can infer that the machine learning model should learn in an unsupervised manner, e.g., using a clustering algorithm. Thus, the model selection process can select clustering model pool 212, which can include various candidate clustering model types such as connectivity-based clustering algorithms (e.g., single-linkage clustering), centroid-based clustering (e.g., K-means clustering), distribution-based clustering (e.g., Gaussian mixture models), and density-based clustering (e.g., DBSCAN). In this case, the model selection process may default to K-means clustering except for specific problem types. As one exception, if the network context data indicates that certain data items should be classified as noise, density-based clustering might be selected instead of K-means, or if the network context data indicates that the data likely follows a Gaussian distribution, then Gaussian mixture models can be selected instead of K-means.

In this case, assume K-means clustering model 602 is selected. Since K is a hyperparameter, the model selection process can select K given various constraints. For instance, assume that there are a total of 150 server racks in the network, and thus the model selection process can infer that K should be no greater than 150 so that each cluster can be mapped to a different rack. As another example, certain heuristic approaches can be used to derive a reasonable value of K.

Next, the feature selection process 216 can explicitly include features as specified by feature information in the network context data 202(3). In this example, the selected features include next-hop feature 604, which identifies the next-hop node for each virtual machine. The feature selection process can also exclude memory utilization, as specified by the network context data 202(3). The feature selection process can also automatically determine that packet destination 606 and TCP window size 608 are also useful features for virtual machine clustering in this example.

Next, the model training process 220 can train the K-means clustering model 602 with the selected features, consistent with the training budget. When training completes, the model training process can output trained K-means model 610, which can generate different clusters of software or hardware nodes in response to data reflecting a given set of network conditions.

### Input and Output Data Examples

The discussion above sets forth specific examples of model types, hyperparameters, network context data, features, and model outputs. However, these specific examples are intended to be illustrative rather than limiting, and the disclosed techniques can be employed to perform alternative types of evaluations using machine learning, using different types of network context data, model types, hyperparameters, and features.

For example, consider the input data provided for evaluation and training. Generally speaking, the disclosed techniques can be used to train machine learning models using any type of data that has a potential relationship to network behavior, including performance, reliability, etc. For instance, the input data can include TCP statistics for each node, such as packets received, discarded, dropped, etc. As another example, the input data can include Netflow data reflecting network bandwidth and traffic patterns between nodes, or Pingmesh data reflecting network latency between any two software nodes.

Furthermore, the input data can reflect configuration parameters of software or hardware nodes (such as change logs) as well as resource utilization parameters such as processor or memory utilization of individual servers.

In some implementations, data distillation can be performed on the input data using domain knowledge to reduce noise in the input space and accelerate model convergence. In other examples, the model training process 220 can split the input data into training/test sets based on the network context data 202. For instance, the network context data may provide information to prevent information leakage between the training and test data sets. As but one example, consider a model that predicts the resource usage of a virtual machine given past resource consumption of other virtual machines running the same application. The network context data can include one or more fields indicating that the input data should be split into training and test sets such that the same virtual machine does not appear in both sets, thus avoiding information leakage between the training and test sets.

In addition to the specific model outputs described above, the disclosed implementations can be employed for various other types of network evaluations. For example, machine learning models can be developed for use in network applications that modify operation of the network in some way, e.g., applications that perform network management, failure diagnosis, risk management, traffic engineering, congestion control, detecting or blocking security threats such as distributed denial of service attacks, virtual machine placement, adaptive video streaming, debugging, etc. In some cases, the machine learning model can be deployed as part of a network application, and in other cases can be deployed as an independent service that can be queried by one or more network applications.

As one example, a machine learning model can be generated for a network management application by training the machine learning model to evaluate potential modifications to a given network and to predict the estimated effect that those modifications might have. For instance, a machine learning model that estimates node-to-node latency could be used to evaluate whether adding new or improved network hardware (e.g., updated switches, routers, etc.) is likely to improve node-to-node latency. As another example, a machine learning model that estimates network reliability could be used to evaluate different potential redundancy or connectivity arrangements between different network devices. More generally, the disclosed implementations can be employed to evaluate different potential software or hardware configurations of the network for criteria such as latency, reliability, availability, etc.

### Model Type, Hyperparameter, and Feature Selection

In addition, some implementations may provide refinements on the above-described model selection processes. For instance, in each of the examples discussed above with respect to FIGS. 4, 5, and 6, the model selection process 204 selected a single model type and a single set of hyperparameters for the selected model type. However, in other implementations, the model selection process can select multiple candidate model types that are subsequently trained and evaluated to identify a selected candidate model for output and subsequent execution. For instance, some implementations may train and evaluate two or more model types from a given model pool and select one of the models for output based on accuracy of the selected model relative to the other models that were trained. Likewise, some implementations may train and evaluate multiple models of the same model type but with different hyperparameters. For example, some implementations may train two or three Gaussian process models with different kernel types to see which kernel type tends to accurately reflect the underlying input data, and then select that kernel type for the final output model. As another example, some implementations may train two or three neural network models using different learning rates, layer types, and/or connectivity arrangements (e.g., sparsely-connected vs. densely-connected) and select a particular neural network model based on the accuracy of the trained model. Thus, the model selection, feature selection, and model training processes are not necessarily performed in series, but rather can be performed iteratively and/or in parallel until a final trained model is selected for output.

Generally, training different model types and/or models with different hyperparameters can be computationally expensive, and thus can quickly expend the training budget. To address this, some implementations use prior knowledge to focus the search for candidate models. As different categories of network problems are identified and machine learning models are successfully deployed to solve those network problems, the model selection process can be continually updated by adding new model selection rules and/or by updating a corresponding machine learning model that implements the model selection process. This, in turn, can reduce the amount of computational resources used for training by removing certain model types and/or hyperparameters from consideration as candidate models for training. As a consequence, as the model training process is refined, the training budget can be used more effectively by focusing training on model types and/or hyperparameters with a high likelihood of performing well for a given application.

In some cases, a meta-learning process is employed that can compare new input data sets to previously-observed input data sets and start the model selection process with a machine learning model that was determined to be effective on a similar input dataset. In further implementations, a taxonomy of problems can be defined, e.g., with broader concepts as higher level nodes (e.g., traffic engineering) and more specific concepts as lower-level nodes (e.g., traffic engineering in a wide-area backbone network of a data center vs. traffic engineering within the data center itself). Then, certain model types can be associated with individual nodes of the taxonomy. As the taxonomy is populated over time, the taxonomy can be used by model selection process 204 to select model types for specific types of network problems that have been previously seen.

In a similar manner, hyperparameter selection can also be informed by prior knowledge. For instance, as models with specific hyperparameter values are successfully identified for specific problem types, those models can be selected again when the same or similar problem types or input data are presented by different users. This can also preserve computational budget for model training process 220. Some model types, such as Bayesian nets or Gaussian process models, may use priors that are selected based on network context. For instance, when a successful model type and associated prior is identified for a given instance of network context data, that same prior and model type may be preferentially selected for future instances of similar network context data.

### Feature Information

In addition, note that the examples of network context data 202 discussed above include examples of feature information that convey binary yes/no indications as to whether a given candidate feature should be used for training. In other implementations, the network context data may include feature information that provides relative weightings for certain candidate features that can be used by the model training process to weight the extent to which those features influence the model outputs.

In further examples, the network context data 202 can specify the meaning of certain features, e.g., by specifying which TCP statistics are associated with source and destination IP addresses. This can be used by a machine learning model to characterize normal vs. abnormal TCP behavior. In a case where the model is requested to identify the entity responsible for a failure, the model can select the entity exhibiting abnormal TCP behavior as likely being the cause of a given failure.

### Feasibility Check

Furthermore, some implementations may employ a feasibility check prior to training and/or outputting a given model. In some cases, the model selection process 204 can evaluate the available input data and training/memory budgets to predict whether it is possible to produce a reasonably accurate model given these constraints. For example, the input data may be too sparse to train a deep neural network model, or too noisy to result in an accurate model. Likewise, the training and/or memory budgets may not allow for adequate training time and/or model size, respectively. In such cases, an output can be provided indicating that machine learning is not feasible given these constraints, potentially with an indication that additional training data, training budget, and/or memory budget would be needed in order to produce a useful model.

As a specific example of a feasibility check, consider an example where a model is requested to predict future packet drops on a network using latency measurements, such as Pingmesh data. In practice, packet drops are often caused by configuration changes made by human operators, and these configuration changes are not reflected in Pingmesh data. As a consequence, it is unlikely that a successful model can be trained for this example.

More generally, some implementations can perform a feasibility check during the model selection process 204. If the feasibility check fails, the feature selection process 216 and model training process 220 can be omitted. To implement the feasibility check, some implementations may evaluate the correlation between the available input data and the requested output of the machine learning model, e.g., by calculating a Spearman correlation for each field of the input data. When the correlation is below a threshold, the model selection process can output an indication that the problem is infeasible.

In further implementations, machine learning models can be used to evaluate the input dataset to quantify how likely it is that an accurate model can be trained from the input data set. In other implementations, the model selection process can involve an iterative series of questions and answers with the operator. For instance, in the example above, the operator could be requested to answer questions such as whether latency should correlate to packet loss, or whether humans or other external factors could influence packet loss. The answers to these questions can be used to both determine whether the problem is feasible and potentially to guide the user to suggest other potential input data that might be more useful for the requested problem.

### Further Discussion

In addition, note that the previous examples in FIGS. 4, 5, and 6 show the network context data 202 in a format that is intended to concisely convey the underlying data to the reader. In some implementations, however, some or all of the network context data can be provided in a formalized description, such as a domain-specific language. Generally, a domain-specific language can have predefined data types and enumerated values that convey the various data discussed herein in a formalized manner. By doing so, different network operators for different networks can represent their network context data in a consistent format that can be understood by the model selection, feature selection, and model training processes discussed herein.

The implementations described herein allow for automated generation of machine learning models that are specifically designed to accomplish network-related tasks. For instance, network context data can be used to constrain selection of the type of models for a given application. This can allow the disclosed implementations to identify appropriate model types without requiring extensive computational resources and/or training data, in contrast to brute force approaches that might generate, train, and evaluate many different potential models without guidance from network context data. In addition, the disclosed implementations can also constrain selection of hyperparameters for a given model type based on network context data.

Furthermore, the disclosed implementations can leverage the domain expertise of network operators by allowing the network operators to provide feature information during the feature selection process. This feature information can be used to constrain selection of candidate features for subsequent model training, e.g., by including or excluding a particular candidate feature in the selected features used for training. By constraining feature selection in this manner, model training can proceed more quickly than might otherwise be the case, e.g., using fewer processor cycles. In addition, irrelevant features can contribute noise that can negatively impact the performance of the final model, e.g., a noise term can sometimes become dominant in Gaussian process models when irrelevant features are used to train the model.

In addition, the disclosed implementations can produce trained machine learning models that meet specified constraints, such as the aforementioned training and/or memory budgets. In some cases, an entity requesting a machine learning model may not have access to a massive server farm with dedicated high-performance hardware for training a machine learning model. In addition, the requesting entity may wish to run the final model on a device with relatively constrained resources, e.g., a typical laptop computer. By allowing such constraints to be expressed as part of the network context data, the disclosed implementations can afford a great deal of flexibility to different entities. As a consequence, an entity with relatively constrained computing resources and no on-hand machine learning expert can nevertheless obtain an appropriate machine learning model to address a wide range of network scenarios.

### Example System

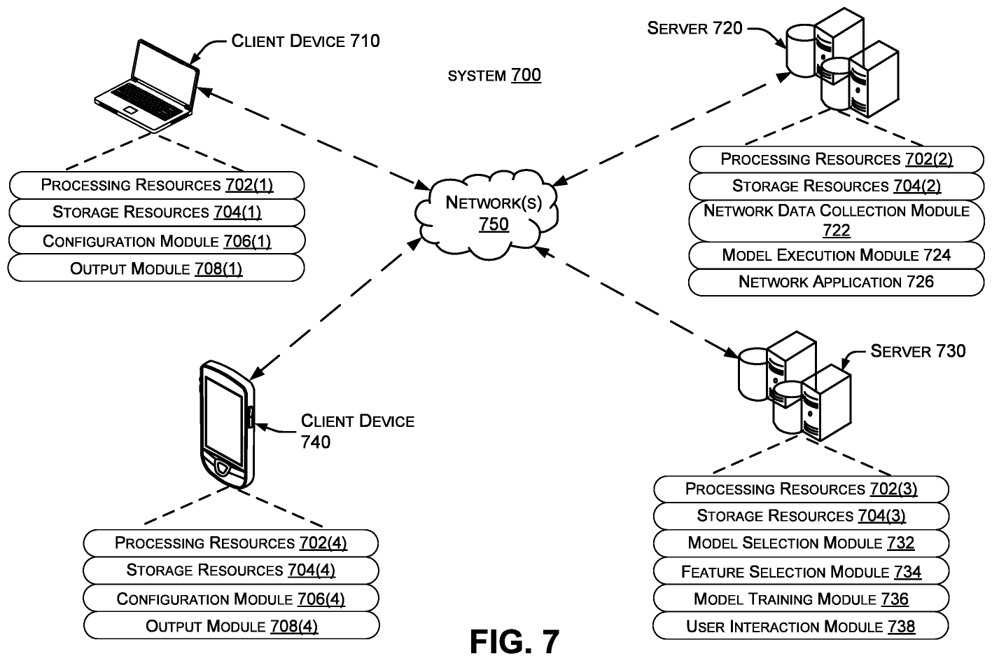

The present implementations can be performed in various scenarios on various devices. FIG. 7 shows one example system 700 in which the present implementations can be employed, as discussed more below.

As shown in FIG. 7, system 700 includes a client device 710, a server 720, a server 730, and a client device 740, connected by one or more network(s) 750. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 7, but particularly the servers, can be implemented in data centers, server farms, etc. Network(s) 750 can include, but are not limited to, network 100 and external network 104, discussed above with respect to FIG. 1.

Certain components of the devices shown in FIG. 7 may be referred to herein by parenthetical reference numbers. For the purposes of the following description, the parenthetical (1) indicates an occurrence of a given component on client device 710, (2) indicates an occurrence of a given component on server 720, (3) indicates an occurrence on server 730, and (4) indicates an occurrence on client device 740. Unless identifying a specific instance of a given component, this document will refer generally to the components without the parenthetical.

Generally, the devices 710, 720, 730, and/or 740 may have respective processing resources 702 and storage resources 704, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 710 and 740 can include configuration module 706(1) and configuration module 706(4), respectively. Generally speaking, the configuration modules can be used to generate certain fields of network context data, such as user-specified fields. Client devices 710 and 740 can also include output modules 708(1) and 708(4). Generally speaking, the output modules can display results produced by executing a trained machine learning model.

Server 720 can host a network data collection module 722, which can collect data from a network such as network 100, shown in FIG. 1. For instance, server 720 can be a server located in facility 102, and can have access to logs produced by any or all of the software and hardware components of network 100. Server 720 can also provide a model execution module 724, which can execute a trained machine model produced using the techniques described herein. Server 720 can also provide a network application 726, which can perform network operations based on a result output by the trained machine learning model.

Server 730 can generally perform processing flow 200, described above with respect to FIG. 2. For instance, server 730 can include a model selection module 732 which can perform the model selection process 204 discussed with respect to FIG. 2. Server 730 can also include a feature selection module 734 which can perform the feature selection process 216 discussed with respect to FIG. 2. Server 730 can also include a model training module 736 which can perform the model training process 220 discussed with respect to FIG. 2. Server 730 can also include a user interaction module 738, which can generate user interfaces to obtain network context data from users of client devices 710 and/or 740. Collectively, the model selection module, feature selection module, model training module, and user interaction module can provide an automated machine learning framework for network evaluation.

In operation, the various components of system 700 can interact as follows. The network data collection module 722 on server 720 can collect various network data during operation of network 100. The configuration module 706 on client device 710 and/or client device 740 can access server 730 to request generation of a machine learning model. The user interaction module 738 can provide one or more interfaces for display on the client devices 710 and 740. The configuration module can provide these interfaces to a user, and the user can interact with the interfaces to supply various network context data parameters, as well as a location of the input data collected by the network data collection module.

The model selection module 732, feature selection module 734, model training module 736, and user interaction module 738 on server 730 can collectively perform processing flow 200 as described above to obtain a final, trained machine learning model. This model can be sent to server 720 for execution. Client devices 710 and/or 740 can interact with the model execution module 724 to view the results of any evaluations performed by the trained model. Client devices 710 and/or 740 can alternatively interact with the network application 726, e.g., via one or more graphical user interfaces that convey operations performed by the network application

### Example User Interfaces

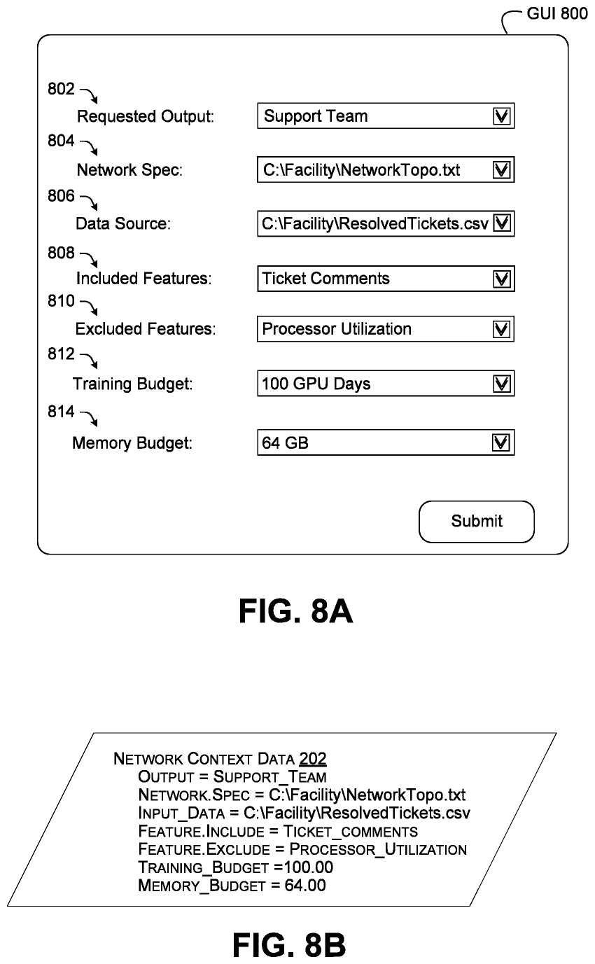

The following discussion introduces some example graphical user interfaces or “GUIs” that can be employed consistently with the concepts described herein. For instance, the GUIs can be generated by the user interaction module 738. FIG. 8A illustrates an example configuration GUI 800 for entering network context data 202. For instance, the configuration module 706 on client device 710 and/or 740 might display configuration GUI 800 to allow a user to input various networking context data values. Note that the configuration GUI is illustrated based on the example processing flow discussed above with respect to FIG. 5.

The configuration GUI includes a first field 802 indicating a requested model output. In this example, the user has requested trouble ticket assignments, but the model output could relate to latency, virtual machine clustering, network availability or reliability, etc. The configuration GUI includes a second field 804 indicating a path name to a network specification. In this case, the user has selected a local file called “NetworkTopo.txt.” The configuration GUI includes a third field 806 indicating a data source for the network data used to train the model. In this case, the user has selected a local file called “ResolvedTickets.csv.” This could be a file with one field indicating which support team ultimately resolved a given ticket, which can serve as a label for other fields indicating other network conditions that can be used as candidate features as described elsewhere herein.

The configuration GUI can include another field 808 identifying designated features to use for training. In this case, the user has indicated that the comments field of the trouble tickets in the data set should be used as features. The configuration GUI can include another field 810 identifying candidate features to exclude. In this case, the user has indicated that processor utilization should be excluded. The configuration GUI includes another field 812 includes a third field indicating a training budget. In this case, the user has selected 100 GPU days. The configuration GUI also includes another field 814 indicating a memory budget. In this case, the user requests that the final model have a size less than or equal to 64 Gigabytes.

Given the data input via the configuration GUI 800, the network context data 202 can be generated. For instance, a domain-specific language can be employed with specific data types, fields, and enumerated values that can be used. FIG. 8B illustrates network context data 202 provided in a domain-specific language format. For instance, the configuration module 706 and/or the user interaction module 738 can automatically generate the domain-specific language representation of the network context data by converting the values input via the configuration GUI 800.

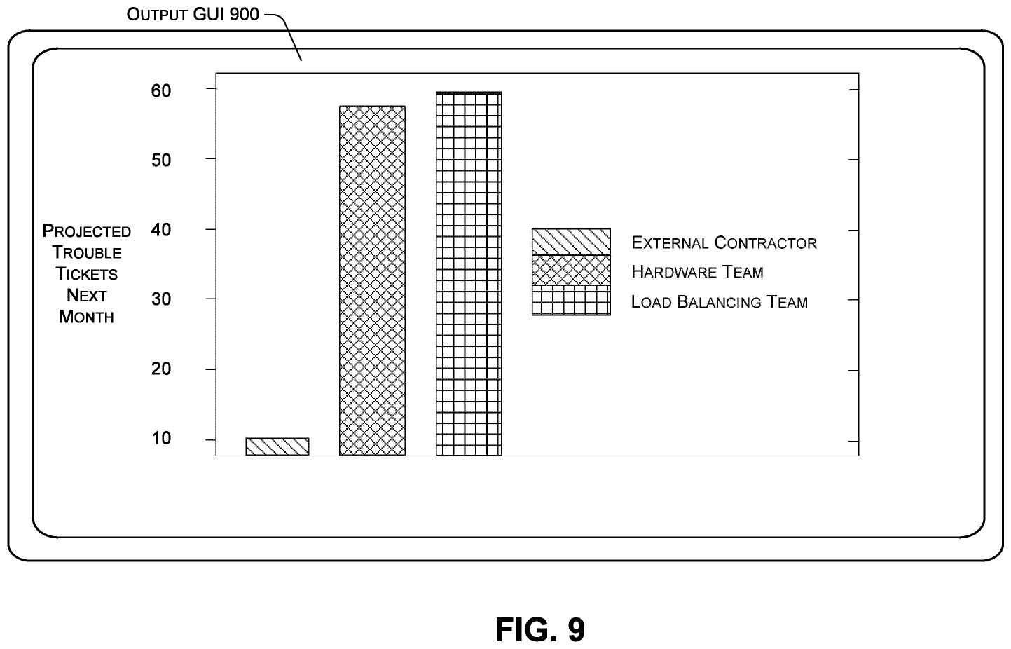

FIG. 9 illustrates an example output GUI 900, which represents the output of the trained machine learning model. In this case, assume that the model execution module 724 on server 720 uses the trained model to predict, for the next month, how many trouble tickets will be assigned to three teams—an internal load balancing team, an internal hardware team, and an external contractor. In this example, the trained model predicts that about 10 trouble tickets will involve external contractors and between 50 and 60 trouble tickets will be resolved by each of the internal teams. GUI 900 can be generated by network application 726 based on one or more results output by the trained machine learning model.

### Further User Interaction Examples

The user interfaces set forth above are merely a few examples, and user interfaces can be used to provide user feedback and/or receive user input at various stages of model development. For instance, some implementations maintain a set of metrics such as flow completion time (for congestion control design), buffer occupancy (for video streaming), link utilization (for traffic engineering), average peering costs (for traffic engineering), etc. For example, the user interaction module 738 can generate a user interface that allows users to select one of these metrics as a criterion for training a given model. The selected criterion can be used for further model training, e.g., using a reinforcement learning approach with a reward function defined over the selected criterion.

The user interaction module 738 can also generate user interfaces can be employed to inform users of various information. For instance, user interfaces can convey the selected model types, hyperparameters, and features. User interfaces can also convey information such as training progress, model accuracy, etc.

The user interaction module 738 can also generate user interfaces that convey information such as which features are particularly useful for model training. For instance, consider an example where the model selection process determines that latency-related features are unrelated to the requested output, but processor-related features are related to the requested output. A user interface can be provided that conveys this information to the user, and gives the user an opportunity to provide more input data. For instance, the user may decide to provide a separate input data set that conveys memory-related features for further evaluation. In other implementations, the user interface can identify certain features that have previously been used successfully to solve similar problems to those requested by the user, thus prompting the user to provide any additional input data that may include those features. In addition, as previously noted, some implementations may pose a series of questions to the user and guide the feature selection process based on answers received from the user, using a user interface generated by the user interaction module.

In some implementations, the network context data 202 is updated iteratively in response to user inputs identifying new input data, new feature information, etc. These updates can be applied by revising the domain-specific language representation of the network context data each time a new user input is received. For instance, the network context data can be updated with new feature information, with a new path to new input data, etc.

In addition, the user interaction module 738 can output results of a feasibility check as described above. For instance, if the candidate features lack a sufficient correlation to the requested output of the model, then the feasibility check may fail and a user interface may be generated that conveys this information to the user. In some cases, model generation may cease in response to a failed feasibility check. This can save the user the cost of performing the training that would have otherwise been involved in generating a machine learning model. In addition, the output of the feasibility check can convey to the user that the candidate feature is not sufficiently correlated to the requested output, which can sometimes prompt the user to identify other candidate features for model training.

### Example Model Generation Method

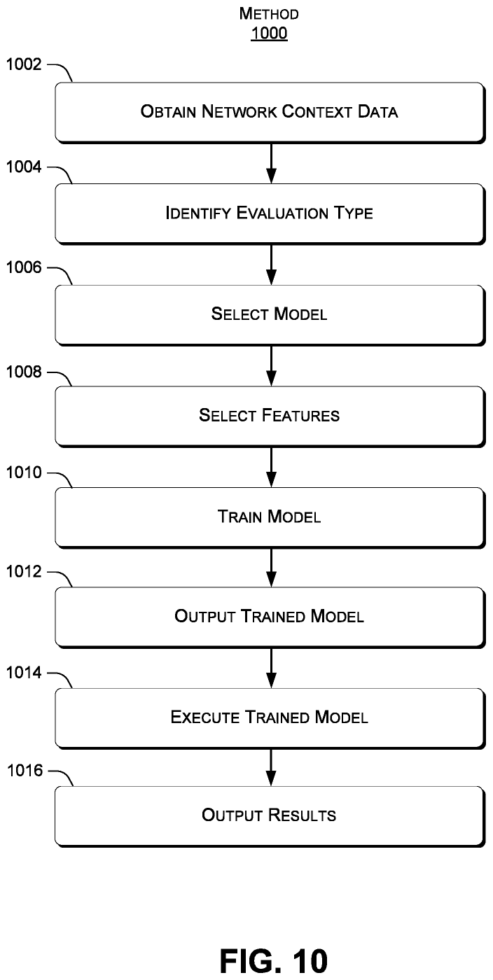

FIG. 10 illustrates an example method 1000, consistent with the present concepts. Method 1000 can be implemented on many different types of devices, e.g., by one or more cloud servers, by a client device such as a laptop, tablet, or smartphone, or by combinations of one or more servers, client devices, etc.

Method 1000 begins at block 1002, where network context data is obtained.

Method 1000 continues at block 1004, where a type of evaluation is identified. For instance, the network context data can explicitly state that a regression, classification, or clustering evaluation is requested. In other cases, this can be inferred from the type of output requested and/or from labels on input data provided with the network context data.

Method 1000 continues at block 1006, where a model is selected. For instance, a model type can be selected based on the network context data. In some cases, various fields of the network context data can be used to constrain the search space for the model type. In addition, block 1006 can also involve selecting model hyperparameters for the selected model type, as discussed elsewhere herein.

Method 1000 continues at block 1008, where features are selected for the model. As noted previously, the network context data can also include feature information that can be used to constrain which fields of the input data are evaluated as potential features.

Method 1000 continues at block 1010, where the selected model is trained using the input data.

Method 1000 continues at block 1012, where the trained model is output. For instance, the trained model can be sent from over a network from one computing device to another, e.g., from server 730 to server 720.

Method 1000 continues at block 1014, where the trained model is executed.

Method 1000 continues at block 1016, where results of the trained model are output.

### Example Model Application Method

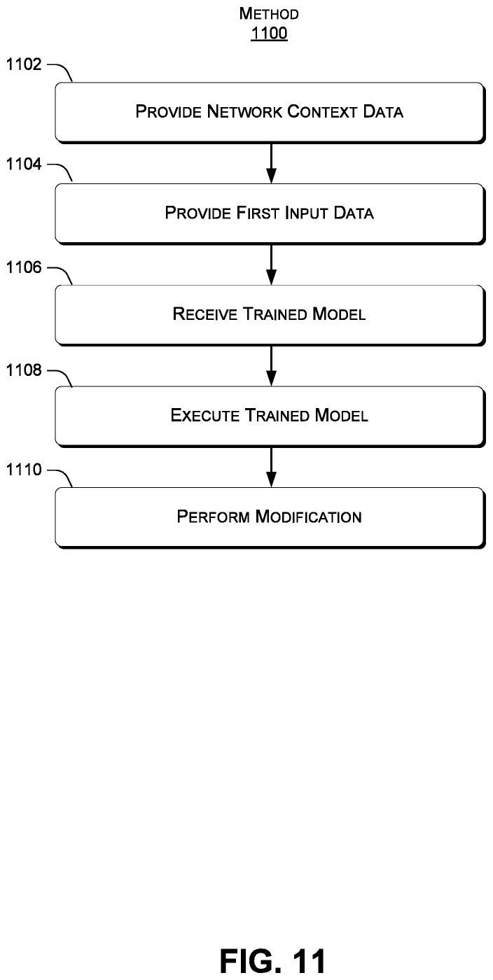

FIG. 11 illustrates an example method 1100, consistent with the present concepts. Method 1100 can be implemented on many different types of devices, e.g., by one or more cloud servers, by a client device such as a laptop, tablet, or smartphone, or by combinations of one or more servers, client devices, etc.

Method 1100 begins at block 1102, where network context data is provided to an automated machine learning framework. For instance, a network operator or engineer associated with network 100 can employ techniques described above to generate the network context data.

Method 1100 continues at block 1104, where first input data is provided to the automated machine learning framework. For instance, the first input data can reflect prior behavior of the network.

Method 1100 continues at block 1106, where a trained machine learning model is received from the automated machine learning framework.

Method 1100 continues at block 1108, where the trained machine learning model is executed on second input data describing behavior of the network. For instance, the second input data can reflect current or recent behavior of the network.

Method 1100 continues at block 1110, where a modification to operation of the network is performed based on a result output by the trained machine learning model. For instance, the modification can be performed by a network application as described elsewhere herein. Alternatively, the modification can be performed by the network operator or engineer, e.g., by reconfiguring, updating, and/or replacing one or more network nodes.

### Device Implementations

As noted above with respect to FIG. 7, system 700 includes several devices, including a client device 710, a server 720, a server 730, and a client device 740. As also noted, not all device implementations can be illustrated and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., compact discs, digital versatile discs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), GPUs, controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, red-green-blue camera systems or using accelerometers/gyroscopes, facial recognition, etc.). Devices can also have various output mechanisms such as printers, monitors, etc. In further implementations, Internet of Things (IoT) devices can be used in place of or in addition to other types of computing devices discussed herein.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

### Additional Examples

Various device examples are described above. Additional examples are described below. One example includes a system comprising a hardware processing unit and a storage resource storing computer-readable instructions which, when executed by the hardware processing unit, cause the hardware processing unit to: obtain network context data identifying a plurality of nodes of a network and identify a specified type of evaluation to be performed on the network. The hardware processing unit can, based at least on the specified type of evaluation, select a particular machine learning model to perform the evaluation and based at least on the network context data, select features to train the particular machine learning model. The hardware processing unit can train the particular machine learning model using the selected features to obtain a trained machine learning model and output the trained machine learning model, the trained machine learning model being configured to perform the specified type of evaluation on the network.

Another example can include any of the above and/or below examples where the computer-readable instructions, when executed by the hardware processing unit, cause the hardware processing unit to identify a training budget for training the particular machine learning model and select a particular model type of the particular machine learning model based at least on the training budget.

Another example can include any of the above and/or below examples where the computer-readable instructions, when executed by the hardware processing unit, cause the hardware processing unit to identify a training budget for training the particular machine learning model and select one or more hyperparameters of the particular machine learning model based at least on the training budget.

Another example can include any of the above and/or below examples where the computer-readable instructions, when executed by the hardware processing unit, cause the hardware processing unit to identify a memory budget for training the particular machine learning model and select a particular model type of the particular machine learning model based at least on the memory budget.

Another example can include any of the above and/or below examples where the computer-readable instructions, when executed by the hardware processing unit, cause the hardware processing unit to identify a memory budget for training the particular machine learning model and select one or more hyperparameters of the particular machine learning model based at least on the memory budget.

Another example can include any of the above and/or below examples where the computer-readable instructions, when executed by the hardware processing unit, cause the hardware processing unit to select hyperparameters of the particular machine learning model based at least on the network context data.

Another example can include any of the above and/or below examples where the computer-readable instructions, when executed by the hardware processing unit, cause the hardware processing unit to select a particular prior for the particular machine learning model based at least on the network context data.

Another example can include any of the above and/or below examples where the computer-readable instructions, when executed by the hardware processing unit, cause the hardware processing unit to, based at least on the network context data: constrain selection of a particular model type of the particular machine learning model from one or more pools of available machine learning model types, constrain selection of hyperparameters of the particular machine learning model from a range of potential hyperparameters for the particular model type, and constrain selection of the selected features to train the particular machine learning model from a plurality of candidate features.

Another example can include any of the above and/or below examples where wherein the computer-readable instructions, when executed by the hardware processing unit, cause the hardware processing unit to, based at least on the network context data, perform a feasibility check to determine whether a successful model is likely to be identified and output a result of the feasibility check via a user interface.

Another example can include any of the above and/or below examples where the computer-readable instructions, when executed by the hardware processing unit, cause the hardware processing unit to receive input data relating network behavior on the network to a plurality of candidate features and based at least on feature information in the network context data, select a subset of features from the candidate features to use as selected features for training the particular machine learning model.

Another example can include any of the above and/or below examples where the computer-readable instructions, when executed by the hardware processing unit, cause the hardware processing unit to train the particular machine learning model to evaluate the network for at least one of network management, traffic engineering, congestion control, virtual machine placement, adaptive video streaming, debugging, or security threats.

Another example can include a method comprising providing network context data identifying nodes of a network to an automated machine learning framework, providing first input data to the automated machine learning framework, the first input data describing behavior of the nodes of the network, receiving a trained machine learning model from the automated machine learning framework, and executing the trained machine learning model on second input data describing behavior of the nodes of the network to obtain a result.

Another example can include any of the above and/or below examples where the method further comprises inputting the result obtained from the trained machine learning model to a networking application that is configured to perform at least one of network management, traffic engineering, congestion control, virtual machine placement, adaptive video streaming, debugging, or blocking of security threats.

Another example can include any of the above and/or below examples where the method further comprises: including, in the network context data, feature information identifying one or more fields of the first input data to use as features for training the machine learning model.

Another example can include any of the above and/or below examples where the network context data reflects a least one of a topology of the network or connectivity of a plurality of virtual machines.

Another example can include any of the above and/or below examples where the method further comprises performing an automated evaluation of traffic flows or configuration data of the network to infer the topology or the connectivity.

Another example can include any of the above and/or below examples where the method further comprises based at least on the result output by the trained machine learning model, performing at least one modification to the network.

Another example can include a computer-readable storage medium storing instructions which, when executed by a processing device, cause the processing device to perform acts comprising: receiving input via a user interface, the input selecting one or more values of network context data for evaluating a network, converting the one or more values of the network context data into a domain-specific language representation of the network context data, and based at least on the domain-specific language representation of the network context data, selecting a particular machine learning model to evaluate the network, the particular machine learning model being selected from one or more pools of candidate machine learning model types.

Another example can include any of the above and/or below examples where the one or more pools of candidate machine learning model types include: a first pool of regression model types including at least a Gaussian process model type, a linear regression model type, a polynomial regression model type, and a neural network regression model type, a second pool of classification model types including a logistic regression model type, a decision tree model type, a random forest model type, a Bayesian network model type, a support vector machine model type, and a deep neural network model type, and a third pool of clustering model types including K-means clustering and density-based clustering.

Another example can include a method comprising obtaining network context data identifying a plurality of nodes of a network, identifying a specified type of evaluation to be performed on the network, selecting a particular machine learning model to perform the evaluation based at least on the specified type of evaluation, selecting features to train the particular machine learning model based at least on the network context data, training the particular machine learning model using the selected features to obtain a trained machine learning model, outputting the trained machine learning model, the trained machine learning model being configured to perform the specified type of evaluation on the network, executing the trained machine learning model on input data describing behavior of the nodes of the network to obtain a result, and inputting the result obtained from the trained machine learning model to a networking application that is configured to perform at least one of network management, traffic engineering, congestion control, virtual machine placement, adaptive video streaming, debugging, or blocking of security threats.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A system comprising:
a hardware processing unit; and
a storage resource storing computer-readable instructions which, when executed by the hardware processing unit, cause the hardware processing unit to:
obtain network context data identifying a plurality of nodes of a network;
identify a specified type of evaluation to be performed on the network;
based at least on the specified type of evaluation, select a particular machine learning model to perform the evaluation;
based at least on the network context data, select features to train the particular machine learning model;
train the particular machine learning model using the selected features to obtain a trained machine learning model; and
output the trained machine learning model, the trained machine learning model being configured to perform the specified type of evaluation on the network.

2. The system of claim 1, wherein the computer-readable instructions, when executed by the hardware processing unit, cause the hardware processing unit to:
identify a training budget for training the particular machine learning model; and
select a particular model type of the particular machine learning model based at least on the training budget.

3. The system of claim 1, wherein the computer-readable instructions, when executed by the hardware processing unit, cause the hardware processing unit to:
identify a training budget for training the particular machine learning model; and
select one or more hyperparameters of the particular machine learning model based at least on the training budget.

4. The system of claim 1, wherein the computer-readable instructions, when executed by the hardware processing unit, cause the hardware processing unit to:
identify a memory budget for training the particular machine learning model; and
select a particular model type of the particular machine learning model based at least on the memory budget.

5. The system of claim 1, wherein the computer-readable instructions, when executed by the hardware processing unit, cause the hardware processing unit to:
identify a memory budget for training the particular machine learning model; and
select one or more hyperparameters of the particular machine learning model based at least on the memory budget.

6. The system of claim 1, wherein the computer-readable instructions, when executed by the hardware processing unit, cause the hardware processing unit to:
select hyperparameters of the particular machine learning model based at least on the network context data.

7. The system of claim 1, wherein the computer-readable instructions, when executed by the hardware processing unit, cause the hardware processing unit to:
select a particular prior for the particular machine learning model based at least on the network context data.

8. The system of claim 1, wherein the computer-readable instructions, when executed by the hardware processing unit, cause the hardware processing unit to:
receive input data relating network behavior on the network to a plurality of candidate features; and
based at least on the network context data, select a subset of features from the candidate features to use as selected features for training the particular machine learning model

9. The system of claim 1, wherein the computer-readable instructions, when executed by the hardware processing unit, cause the hardware processing unit to:
based at least on the network context data:
constrain selection of a particular model type of the particular machine learning model from one or more pools of available machine learning model types;
constrain selection of hyperparameters of the particular machine learning model from a range of potential hyperparameters for the particular model type; and
constrain selection of the selected features to train the particular machine learning model from a plurality of candidate features.

10. The system of claim 1, wherein the computer-readable instructions, when executed by the hardware processing unit, cause the hardware processing unit to:
based at least on the network context data, perform a feasibility check to determine whether a successful model is likely to be identified; and
output a result of the feasibility check via a user interface.

11. The system of claim 1, wherein the computer-readable instructions, when executed by the hardware processing unit, cause the hardware processing unit to:
receive input data relating network behavior on the network to a plurality of candidate features; and
based at least on feature information in the network context data, select a subset of features from the candidate features to use as selected features for training the particular machine learning model.

12. The system of claim 1, wherein the computer-readable instructions, when executed by the hardware processing unit, cause the hardware processing unit to:
train the particular machine learning model to evaluate the network for at least one of network management, traffic engineering, congestion control, virtual machine placement, adaptive video streaming, debugging, or security threats.

13. A method comprising:
providing network context data identifying nodes of a network to an automated machine learning framework;
providing first input data to the automated machine learning framework, the first input data describing behavior of the nodes of the network;
receiving a trained machine learning model from the automated machine learning framework; and
executing the trained machine learning model on second input data describing behavior of the nodes of the network to obtain a result.

14. The method of claim 13, further comprising:
inputting the result obtained from the trained machine learning model to a networking application that is configured to perform at least one of network management, traffic engineering, congestion control, virtual machine placement, adaptive video streaming, debugging, or blocking of security threats.

15. The method of claim 13, further comprising:
including, in the network context data, feature information identifying one or more fields of the first input data to use as features for training the machine learning model.

16. The method of claim 13, wherein the network context data reflects a least one of a topology of the network or connectivity of a plurality of virtual machines.

17. The method of claim 16, further comprising:
performing an automated evaluation of traffic flows or configuration data of the network to infer the topology or the connectivity.

18. The method of claim 13, further comprising:
based at least on the result output by the trained machine learning model, performing at least one modification to the network.

19. A computer-readable storage medium storing instructions which, when executed by a processing device, cause the processing device to perform acts comprising:
receiving input via a user interface, the input selecting one or more values of network context data for evaluating a network;
converting the one or more values of the network context data into a domain-specific language representation of the network context data; and
based at least on the domain-specific language representation of the network context data, selecting a particular machine learning model to evaluate the network, the particular machine learning model being selected from one or more pools of candidate machine learning model types.

20. The computer-readable storage medium of claim 19, wherein the one or more pools of candidate machine learning model types include:
a first pool of regression model types including at least a Gaussian process model type, a linear regression model type, a polynomial regression model type, and a neural network regression model type;
a second pool of classification model types including a logistic regression model type, a decision tree model type, a random forest model type, a Bayesian network model type, a support vector machine model type, and a deep neural network model type; and
a third pool of clustering model types including K-means clustering and density-based clustering.
